(19) United States
(12) Patent Application Publication
(10) Pub. No.: US 2026/0250802 A1
(43) Pub. Date: Aug. 27, 2026

(54) COPPER ALLOY SHEET

(71) Applicant: Kabushiki Kaisha Kobe Seiko Sho (Kobe Steel, Ltd.), Kobe-shi (JP)

(72) Inventors: Ryosuke ISHIKAWA, Kobe-shi (JP); Hisao SHISHIDO, Kobe-shi (JP); Yuya SUMINO, Shimonoseki-shi (JP)

(73) Assignee: Kabushiki Kaisha Kobe Seiko Sho (Kobe Steel, Ltd.), Kobe-shi (JP)

(21) Appl. No.: 19/159,210

(22) PCT Filed: Feb. 7, 2024
(86) PCT No.: PCT/JP2024/004169

§ 371 Date: Aug. 22, 2025

(30) Foreign Application Priority Data
Feb. 24, 2023 (JP) 2023-027680

(51) Int. Cl. C22C 9/06; C22F 1/00; C22F 1/08

(52) U.S. Cl. CPC C22C 9/06; C22F 1/002; C22F 1/08

(57) ABSTRACT

A copper alloy sheet made of 1.2 to 3.0 mass % Ni; 0.10 to 1.0 mass % Si; and 0.01 to 3.0 mass % Zn, with the balance being Cu and inevitable impurities. In an EBSD measurement on a cross-section in the thickness direction, within a depth range of up to 10% of the sheet thickness from the surface, a total area fraction of a portion having a CI value of less than 0.1 is 10.0% to 60.0%.

### TECHNICAL FIELD

The present disclosure relates to a copper alloy sheet, and particularly to a copper alloy sheet having high proof stress and excellent bending workability.

### BACKGROUND ART

Copper alloys for electric and electronic components are required to have high conductivity, high proof stress (yield stress), high tensile strength, excellent bending workability, excellent fatigue resistance, excellent stress relaxation resistance, high Young's modulus, and the like. In order to satisfy these properties, the metallographic structure of a copper alloy sheet is controlled.

Achieving both high strength (high proof stress and high tensile strength) and excellent bending workability is particularly difficult, and therefore various contrivances have been made.

Patent Documents 1 to 4 disclose that a KAM value is introduced as an index of dislocation density in a copper alloy sheet and that the KAM value is set to 1.0 to 3.0 to balance the strength and the bending workability in the copper alloy sheet.

The KAM value is to determine the average of the dislocation density present in the metallographic structure in the measurement region.

Patent Document 5 discloses that a copper alloy sheet capable of achieving excellent bending workability and a bent portion external appearance having no wrinkle is obtained by reducing the shear band near the surface of the copper alloy sheet, without deterioration of physical property values such as a proof stress.

The shear band is a structure in which deformation is locally concentrated, that is, a portion in which a large amount of strain is accumulated to increase the dislocation density, and the shear band is less likely to deform than the surrounding structure. Therefore, when a material including a shear band is bent, uneven elongation occurs from the shear band to cause a wrinkle and a crack easily. Meanwhile, unless rolling is performed up to formation of a shear band, work hardening cannot be performed, and the required alloy strength cannot be achieved.

Patent Document 5 focuses on the distribution of shear bands, and describes that if the number of shear bands is reduced near the surface of the copper alloy sheet and increased inside the copper alloy sheet, the bending workability can be improved.

Patent Document 6 discloses that a copper alloy sheet excellent in press workability, bending workability, and strength is obtained by setting the polar density of the shear texture from the surface of the copper alloy sheet to a depth of 5 μm to 2 to 8.

In cold rolling, a copper alloy sheet usually has different textures formed in a surface layer portion, which is in contact with a roll during rolling, and in a central portion of the sheet. This is because in the surface layer portion, the material is shear-deformed due to the influence of the frictional force with the roll. Patent Document 6 refers to the structure of the surface layer portion as the surface texture (shear texture).

The polar density of the shear texture is obtained by macroscopically measuring the crystal orientation of the copper alloy sheet with an X-ray diffraction method.

Patent Documents 7 to 9 disclose the KAM value of a copper alloy sheet and a physical property related to the KAM value.

Patent Documents 7 to 8 describe a relationship between the KAM value, which is an index of dislocation density of the copper alloy sheet, and corrosion due to etching.

Patent Document 9 discloses that excellent fatigue resistance is exhibited by setting the Goss orientation density measured with the EBSD method to 2.0 to 6.0% and the average of KAM to 0.9 to 1.5°.

### PRIOR ART DOCUMENTS

### Patent Documents

Patent Document 1: Japanese Patent No. 5690170
Patent Document 2: Japanese Patent No. 5314663
Patent Document 3: Japanese Patent No. 5476149
Patent Document 4: WO 2013/018228 A
Patent Document 5: Japanese Patent No. 5281031
Patent Document 6: JP-A-2010-222618
Patent Document 7: Japanese Patent No. 06154565
Patent Document 8: Japanese Patent No. 06152212
Patent Document 9: Japanese Patent No. 05192536

### SUMMARY OF THE INVENTION

### Problems to be Solved by the Invention

In the automobile field, various kinds of electronic devices are being mounted, and their number is increasing due to compliance with environmental regulations, the pursuit of comfort and safety, and advanced driver assistance systems based on a recent trend of CASE (connected, autonomous, shared & services, electric). Therefore, further downsizing is required for terminals, connectors, relay components, and the like. Manufacturing a small component requires realizing further excellent bending workability (in particularly, bendability under close-contact conditions (close-contact bendability)) while maintaining high proof stress as in Patent Documents 1 to 6.

Patent Documents 7 to 9 does not disclose a method of improving the bending workability and the proof stress.

An object of an embodiment of the present invention is to provide a copper alloy sheet capable of realizing high proof stress and excellent bending workability.

### Solutions to the Problems

An aspect 1 of the present invention is
a copper alloy sheet including:
Ni: 1.2 to 3.0 mass %;
Si: 0.10 to 1.0 mass %; and
Zn: 0.01 to 3.0 mass %,
with the balance being Cu and inevitable impurities,
wherein, in EBSD measurement on a cross-section in the thickness direction, within a depth range of up to 10% of the sheet thickness from the surface, a total area fraction of a portion having a CI value of less than 0.1 is 10.0% to 60.0%.

An aspect 2 of the present invention is
the copper alloy sheet according to the aspect 1, further including
at least one element selected from Sn and Mg, in an amount of
Sn: more than 0 mass % and 1.0 mass % or less, and
Mg: more than 0 mass % and 0.2 mass % or less.

An aspect 3 of the present invention is the copper alloy sheet according to the aspect 1 or 2, further including one or more elements selected from the group consisting of Al, Mn, Cr, Ti, Zr, Fe, P, and Ag in a total amount of more than 0 mass % and 0.5 mass % or less.

### Effects of the Invention

According to an embodiment of the present invention, it is possible to provide a copper alloy sheet capable of realizing high proof stress and excellent bending workability.

### BRIEF DESCRIPTION OF DRAWINGS

FIG. 1A is a schematic sectional view of a jig used in a close-contact bending test.

FIG. 1B is a schematic sectional view of a jig used in a close-contact bending test.

FIG. 1C is a schematic sectional view of a jig used in a close-contact bending test.

FIG. 2A is an optical microscope photograph of a cross section (observation surface) of a sample piece subjected to close-contact bending in a close-contact bending test.

FIG. 2B is an optical microscope photograph of a cross section (observation surface) of a sample piece subjected to close-contact bending in a close-contact bending test.

### DETAILED DESCRIPTION

The present embodiment provides a Cu—Ni—Si-based copper alloy sheet having high proof stress and excellent bending workability by utilizing a shear band that is a worked structure.

The term “shear band” refers to a structure in which deformation is locally concentrated, that is, a portion in which a large amount of strain is accumulated to increase the dislocation density. It has been generally considered that development of a shear band reduces the elongation of the copper alloy sheet and worsens the bending workability. Therefore, it has been considered that setting a low working rate in finish cold rolling to suppress generation of a shear band is effective for improving the bending workability. However, high proof stress is not exhibited at a low finish rolling ratio, so that achieving both high proof stress and excellent bending workability (that is, improvement in balance between the proof stress and the bending workability) has been difficult.

As a result of intensive studies, the present inventors have found that in the case of a Cu—Ni—Si-based copper alloy sheet having a predetermined chemical component composition, a copper alloy sheet excellent in balance between the proof stress and the bending workability is obtained by controlling the area fraction of a portion including a shear band in an observation region in the vicinity of the surface.

In the present embodiment, a reliability index CI (confidence index) value in EBSD measurement is used as an index related to a shear band. The CI value is obtained by observing the presence or absence of a local dislocation (presence or absence of a shear band) at the measurement point. Measurement is performed at a large number of measurement points in the entire measurement region, the presence or absence of a dislocation is determined at each measurement point, and thus the fraction of a portion including a dislocation in the measurement region (area fraction) can be obtained.

Other than the CI value, the KAM value used in Patent Documents 1 to 4 and 7 to 9 serves as an index of dislocation. The KAM value in Patent Documents 1 to 4 and 7 to 9 is to determine the average of the number of dislocations included in the measurement region, and is not obtained by measuring the presence or absence of a local dislocation. Therefore, the KAM value is greatly different from the CI value of the present embodiment in that the area fraction of the portion including a dislocation is not measured.

The presence or absence of a local dislocation cannot be determined by measurement of the polar density of the shear texture in Patent Document 6 in which the crystal orientation of the copper alloy sheet is macroscopically measured with an X-ray diffraction method.

Hereinafter, the chemical component composition, the structure, and the manufacturing method of the copper alloy sheet according to the present embodiment will be described.

### 1. Chemical Component Composition

(1) Ni: 1.2 to 3.0 mass %

The content of Ni is 1.2 to 3.0 mass %.

High strength and high conductivity can be obtained by aging precipitation of a Ni—Si-based compound with Ni and Si. The effect is small when the content of Ni is less than 1.2 mass %, so that such a content is inappropriate. When the content of Ni is more than 3.0 mass %, a coarse compound is generated by hot rolling or solution treatment to worsen the bending workability, so that such a content is inappropriate.

The lower limit of Ni is preferably 1.3 mass %, and more preferably 1.35 mass %. The upper limit of Ni is preferably 2.5 mass %, and more preferably 2.0 mass %.
(2) Si: 0.10 to 1.0 mass %

The content of Si is 0.10 to 1.0 mass %.

As described above, high strength and high conductivity can be obtained by aging precipitation of a Ni—Si-based compound with Si and Ni. The effect is small when the content of Si is less than 0.10 mass %, so that such a content is inappropriate. When the content of Si is more than 1.0 mass %, a coarse compound is generated by hot rolling or solution treatment to worsen the bending workability, so that such a content is inappropriate.

The lower limit of Si is preferably 0.15 mass %, and more preferably 0.20 mass %. The upper limit of Si is preferably 0.80 mass %, and more preferably 0.60 mass %.
(3) Zn: 0.01 to 3.0 mass %

The content of Zn is 0.01 to 3.0 mass %.

Addition of Zn is expected to lower the stacking fault energy, promote introduction of deformation twin during finish rolling, and increase the strength of the copper alloy sheet. Furthermore, addition of Zn improves the thermal peeling resistance of the solder and the Sn plating. However, when the amount of Zn added is more than 3.0 mass %, the wettability of the solder deteriorates, so that such an amount is inappropriate. When the amount of Zn added is less than 0.01 mass %, the improvement in thermal peeling resistance of the solder and the Sn plating is insufficient, so that such an amount is inappropriate.

The lower limit of Zn is preferably 0.15 mass %, more preferably 0.30 mass %, and still more preferably 0.50 mass %. The upper limit of Zn is preferably 2.0 mass %, and more preferably 1.5 mass %.
(4) Balance

In one preferred embodiment, the balance is Cu and an inevitable impurity. As the inevitable impurity, a trace element that is brought is allowed to be mixed according to the situation of raw materials, materials, manufacturing equipment, and the like.

The copper alloy sheet is not limited to this embodiment, and may further include any other element as long as the properties of the copper alloy sheet of the present invention can be maintained. Examples of other elements that can be optionally included as described above are shown below.
(5) At least one element selected from Sn and Mg, in an amount of Sn: more than 0 mass % and 1.0 mass % or less, and Mg: more than 0 mass % and 0.2 mass % or less

In the case of adding Sn, the content of Sn is preferably more than 0 mass % and 1.0 mass % or less.

Addition of Sn is expected to increase the strength of the copper alloy sheet by solid solution strengthening and improve the stress relaxation resistance. In order to exhibit the above effect, the content of Sn is preferably more than 0 mass %. Furthermore, if the content of Sn is set to 1.0 mass % or less, the conductivity, which is a property required for a copper alloy for a terminal, can be kept high.

The lower limit of Sn is more preferably 0.005 mass %, still more preferably 0.01 mass %, and particularly preferably 0.05 mass %. The upper limit of Sn is more preferably 0.7 mass %, and still more preferably 0.5 mass %.

In the case of adding Mg, the content of Mg is preferably more than 0 mass % and 0.2 mass % or less.

Addition of Mg is expected to increase the strength of the copper alloy sheet by solid solution strengthening and improve the stress relaxation resistance. In order to exhibit the above effect, the content of Mg is preferably more than 0 mass %. Furthermore, if the content of Mg is set to 0.2 mass % or less, the conductivity, which is a property required for a copper alloy for a terminal, can be kept high.

The lower limit of Mg is more preferably 0.005 mass %, still more preferably 0.01 mass %, and particularly preferably 0.05 mass %. The upper limit of Mg is preferably 0.17 mass %, and more preferably 0.15 mass %.
(6) One or more selected from the group consisting of Al, Mn, Cr, Ti, Zr, Fe, P, and Ag at content of more than 0 mass % and 0.5 mass % or less in total

Addition of these elements is expected to increase the strength of the copper alloy sheet by solid solution strengthening and improve the stress relaxation resistance. In order to exhibit the above effect, the total content of these elements is preferably more than 0 mass %. Furthermore, if the total content of these elements is set to 0.5 mass % or less, the conductivity, which is a property required for a copper alloy for a terminal, can be kept high.

### 2. Structure

The copper alloy sheet according to the present embodiment has a metallographic structure including many shear bands (having a high number density of shear bands) in the vicinity of the surface. Specifically, in electron back scattered diffraction (EBSD) measurement in a cross section in the thickness direction in a range from the surface of the copper alloy sheet to a depth of 10% of the sheet thickness, the total area fraction of a portion having a confidence index (CI) value of less than 0.1 is controlled from 10.0 to 60.0%.

The metallographic structure of the outermost surface portion of the copper alloy sheet is greatly affected by bending strain to affect the bendability, and therefore the present inventors have considered that the bendability of the copper alloy sheet can be known by setting a measurement region in a shallow portion in the vicinity of the surface. In the present embodiment, the measurement region is set from the surface of the copper alloy sheet to a depth of 10% of the sheet thickness.

The CI value acquired by EBSD is used as a method of evaluating the number density of shear bands. The confidence index (CI) value is a reliability index that is an index indicating the reliability of the crystal orientation, and has a value of 0 to 1. The quality of crystallinity of the observation point can be evaluated by using the CI value, and a place in which deformation is concentrated, such as a shear band, has a low CI value.

In the present embodiment, in a case where the CI value of the measurement point is less than 0.1, it is determined that a shear band is formed at the measurement point. EBSD measurement is performed over the entire measurement region, and the total area of portions having a CI value of less than 0.1 (total area S2 (μm²)) is determined. Then, the ratio (S2/S1) of the total area S2 (μm²), where the CI value is less than 0.1, to the total measurement area S1 (μm²), in which the EBSD measurement is performed, is referred to as the “total area fraction of a portion having a CI value of less than 0.1” or “amount of shear bands”.

The total area ratio (S2/S1) of portions having a CI value of less than 0.1 ranges from 0 to 100%, and is 0% in a case where no shear band is present within the measurement region, and is 100% in a case where a shear band is present in the entire metallographic structure within the measurement region.

In the present embodiment, the bending workability is improved by controlling the total area fraction of a portion having a CI value of less than 0.1, to 10.0 to 60.0% in a range from the surface of the copper alloy sheet to a depth of 10% of the sheet thickness. The reason is not clear why the bending working rate can be improved by controlling the total area fraction, but it is presumed that the mechanism is as follows.

At the time of bending, fine wrinkles are generated from a shear band. When many wrinkles are generated, bending strain is distributed to these wrinkles. That is, it is considered that concentration of bending strain on a specific wrinkle is suppressed and thus growth of the wrinkle to a crack is suppressed.

If the total area fraction of a portion having a CI value of less than 0.1 is less than 10.0%, the effect of suppressing concentration of bending strain on each wrinkle is small, and a crack is easily generated. Meanwhile, if the total area fraction is more than 60.0%, the shear bands are excessively dense, and thus the bending workability deteriorates.

The total area fraction of a portion having a CI value of less than 0.1 is preferably 20.0% or more, and more preferably 30.0% or more, and is preferably 50.0% or less.

The measurement of the CI value is performed as follows.

The copper alloy sheet is cut along a plane passing through the vicinity of the center of the sheet width and perpendicular to the sheet width direction, and the structure of the cut surface is observed. In the cut surface, the EBSD measurement is performed in a measurement region set to a range having a dimension (width) in the rolling direction of about 150 μm between the surface of the copper alloy sheet and the position at which the depth from the surface is 10% of the sheet thickness. For example, in a case where the sheet thickness is 150 μm, the area of the measurement region is dimension in depth direction of 15 μm×width of about 150 μm=about 2250 μm².

The EBSD measurement is performed in the measurement region at a measurement step interval of 0.05 μm or 0.025 μm. The EBSD data is analyzed with image analysis software to determine the CI value, and evaluation of the number density of shear bands (calculation of the total area fraction of a portion having a CI value of less than 0.1) is performed.

### 3. Manufacturing Method

Next, a method of manufacturing the copper alloy sheet according to the present invention will be described.

The copper alloy sheet can be manufactured by performing the steps of hot rolling, cold rolling, solution treatment, aging treatment, finish cold rolling, and low-temperature annealing in this order. Cold rolling is not performed between the solution treatment and the aging treatment.

The copper alloy sheet of the present invention is basically a rolled copper alloy sheet, and examples of the copper alloy sheet of the present invention also include a strip obtained by slitting the rolled copper alloy sheet in the width direction and a coiled product of such a sheet or strip.

### (Hot Rolling, Cold Rolling)

First, a copper alloy ingot having a desired chemical component composition is prepared. The copper alloy ingot is heated at 900 to 1000° C. for 30 to 300 minutes, and then hot-rolled. Then, the copper alloy ingot is cold-rolled to a target thickness (for example, 0.2 to 1 mm). The target thickness is appropriately changed in consideration of the finish rolling ratio and the final sheet thickness of the copper alloy sheet.

### (Solution Treatment)

In the subsequent solution treatment, a heat treatment is performed in which the resulting copper alloy sheet is heated to 700 to 850° C. at a heating rate of 80° C./sec or more and held at this temperature for 10 to 120 seconds (sec.). Then, the copper alloy sheet is cooled at a cooling rate of 80° C./sec or more.

The conditions for the solution treatment are different from those in Patent Document 2 in that the heating rate is remarkably high and the holding time is short.

### (Aging Treatment)

After the solution treatment, a heat treatment is performed in which the copper alloy sheet is heated to 400 to 500° C. at a heating rate of 40 to 80° C./hr and held at this temperature for 2 to 7 hr. Then, the copper alloy sheet is cooled at a cooling rate of 20 to 60° C./hr. This treatment is performed for aging precipitation (aging treatment) of Ni—Si.

The present invention is different from Patent Document 7 in that rolling is not performed between solution treatment and aging treatment and that the heat treatment time in aging treatment is short.

### (Finish Cold Rolling)

After the aging treatment, the copper alloy sheet prepared under the above conditions is subjected to finish cold rolling at a rolling reduction of 40 to 80%.

Deformation of the metal material in finish cold rolling causes slip deformation and shear deformation. If a precipitate is formed in the matrix phase, the material has high deformation resistance, and slip deformation is suppressed. Therefore, the finish cold rolling after aging precipitation in the aging treatment promotes shear deformation, and thus a shear band can be efficiently introduced. When the rolling reduction in finish cold rolling (referred to as “finish rolling ratio”) is lower than 40%, introduction of shear bands is insufficient, and the bending workability deteriorates.

Meanwhile, if the finish rolling ratio is more than 80%, shear bands are excessively introduced, so that the bending workability deteriorates. If the finish rolling ratio is set to 40 to 80%, shear bands are appropriately introduced, and the bending workability is improved.

The lower limit of the finish rolling ratio is preferably 45% and more preferably 50%, and is preferably appropriately set according to the solution treatment condition and the aging condition before the finish cold rolling.

### (Low-Temperature Annealing)

After the finish cold rolling, low-temperature annealing is performed for the purpose of reducing the residual stress of the sheet material and improving the spring limit value and the stress relaxation resistance. The heating temperature at this stage is preferably set in the range of 250 to 450° C. Annealing at such a low temperature reduces the residual stress inside the sheet material, and can increase the bending workability and the fracture elongation with little decrease in strength. The annealing can also increase the conductivity. If the heating temperature during the low-temperature annealing exceeds the upper limit temperature (500° C.) of the heating temperature in the aging treatment, the sheet material is significantly softened. Therefore, the upper limit of the heating temperature during the low-temperature annealing is set to 450° C. Meanwhile, if the heating temperature is lower than 250° C., the effect of improving each property described above is less likely to be sufficiently exhibited.

A person skilled in the art who is in contact with the method of manufacturing the copper alloy sheet according to an embodiment of the present invention described above may be able to obtain the copper alloy sheet according to the present invention with a manufacturing method different from the above-described manufacturing method by trial and error.

### Examples

### (Preparation of Copper Alloy Sheet)

A copper alloy ingot (thickness: 45 mm) was prepared in an induction furnace, targeting the composition shown in Table 1. This ingot was heated at 950° C. for 30 minutes or more, then hot-rolled to a thickness of about 20 mm, and cooled with water to obtain a hot-rolled sheet. Then, face milling was performed to remove an oxide scale on the surface of the hot-rolled sheet, and cold rolling was performed to a thickness of about 2 mm. Then, the resulting sheet was subjected to pre-rolling (cold rolling), solution treatment, aging treatment, finish cold rolling, and low-temperature annealing sequentially under the working and heat treatment conditions shown in Table 2 to obtain a copper alloy sheet sample having a sheet thickness of about 0.15 mm (150 μm).

In the solution treatment, the heating rate was 80° C./see or more and the cooling rate was 80° C./see or more, and in the aging treatment, the heating rate was 40 to 80° C./hr and the cooling rate was 20 to 60° C./hr.

### (Observation of Structure)

The copper alloy sheet sample was cut along a plane passing through the vicinity of the center of the sheet width and perpendicular to the sheet width direction, and the structure of the cut surface was observed. First, the copper alloy sheet was cut and then embedded in a resin, and the observation surface was prepared. The observation surface was prepared by mechanical polishing, buffing, and then polishing using a cross section polisher (SM-09010 manufactured by JEOL Ltd.). In the prepared observation surface, EBSD measurement was performed in a measurement region having a dimension (width) in the rolling direction of about 150 μm from the surface of the copper alloy sheet to a depth of 15 μm (corresponding to 10% of the sheet thickness).

In the EBSD measurement, Ultra55 manufactured by ZEISS was used, and measurement was performed in the measurement region at a measurement step interval of 0.05 μm or 0.025 μm. A virtual grid was assumed such that the measurement points corresponded to grid points, and the ratio (X2/X1) of the number X2 of the measurement points (grid points) having a CI value of less than 0.1 to the total number X1 of the measurement points (grid points) within the measurement region was regarded as the total area fraction (%). The obtained value of the total area fraction was described as the “amount of shear bands” in Table 3.

The CI value at each measurement point was obtained by analyzing EBSD data with image analysis software (OIM manufactured by TSL Solutions). In the analysis of the EBSD data with OIM, a measurement parameter (Number of Bands)/(Max Number of Bands) was converted into a CI value and analysis was performed.

### (Evaluation of Property)

A tensile test (0.2% proof stress in T. D. direction), the conductivity measurement, and the close-contact bendability were conducted to evaluate properties of the copper alloy sheet sample.
Tensile test:

From the copper alloy sheet sample, a test piece for a tensile test was prepared and used in the tensile test.

The tensile test was performed using a JIS No. 5 test piece in which the longitudinal direction was set to the direction perpendicular to the rolling direction with AG-IS (100 kN) manufactured by SHIMADZU CORPORATION under the conditions of room temperature, a test speed of 5 mm/min, and a gauge length of 50 mm to measure the 0.2% proof stress (MPa). From this tensile test result, the 0.2% proof stress (Y.S.) in the direction perpendicular to the rolling direction (T.D. direction) was evaluated as acceptable when 670 MPa or more, good when 720 MPa or more, and excellent when 750 MPa or more.
Conductivity:

A test piece for conductivity measurement was prepared from the copper alloy sheet sample, and the conductivity of it was measured.

The electrical resistance was measured using a test piece having a width of 10 mm×a length of 180 mm with a longitudinal direction perpendicular to the rolling direction with a double bridge resistance measuring device (275200 manufactured by Yokogawa Electric Corporation), and the conductivity was calculated with an average cross-sectional area method. In this measurement, a sample having a conductivity of 37% IACS or more was evaluated as having high conductivity.
Close-Contact bendability

The close-contact bending test of the copper alloy sheet sample was performed with the following method.

A sample piece cut out from the copper alloy sheet sample into a dimension of 10 mm in the rolling direction×10 mm in the sheet width direction was polished to a sheet thickness of about 0.1 mm by one-side polishing, and a good-way (with a bending axis perpendicular to the rolling direction) close-contact bending test was performed so that the polished surface was on the inner side in bending.

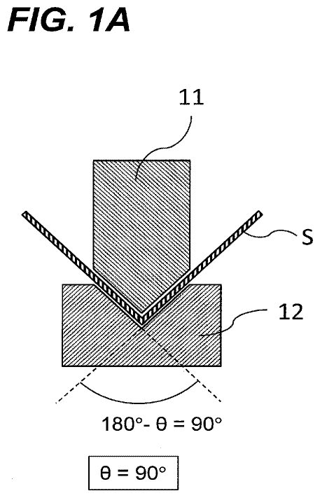

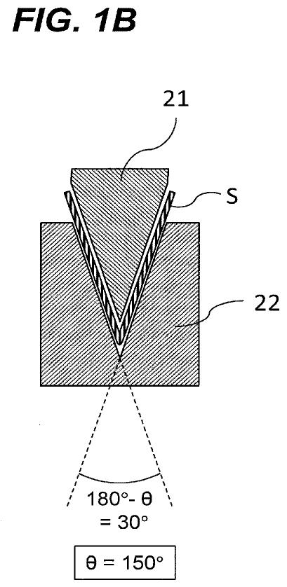

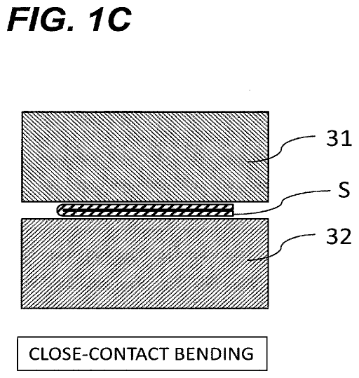

In the close-contact bending test, V-shaped bending jigs (reference numerals 11 and 12 in FIG. 1A and reference numerals 21 and 22 in FIG. 1B) and block-shaped jigs (reference numerals 31 and 32 in FIG. 1C) were used. First, the polished test piece S was placed between the jigs 11 and 12 as shown in FIG. 1A and bent with a radius R=0.05 and an angle θ=90° under a load of 200 N. Then, it was placed between the jigs 21 and 22 as shown in FIG. 1B, and bent at R=0.05 and θ=150° under a load of 200 N. Finally, the V-shaped test piece S was placed between the block-shaped jigs 31 and 32 as shown in FIG. 1C, and flatten under a load of 200 N to perform close-contact bending.

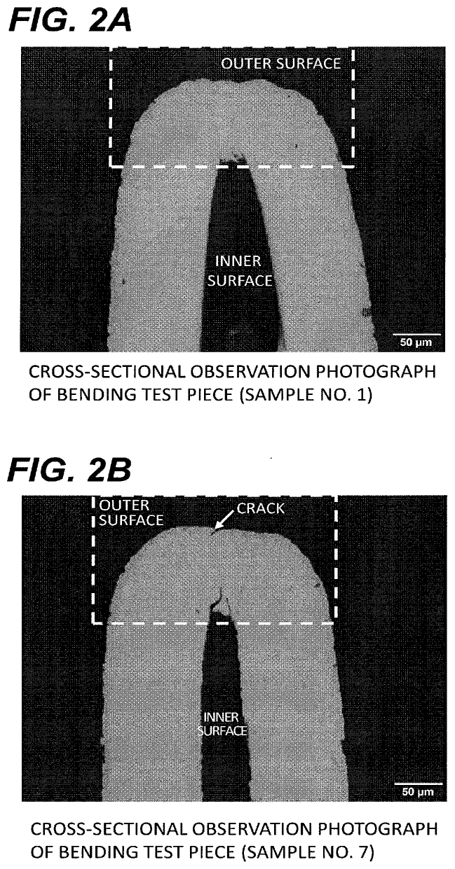

The close-contact bendability was determined by observing the cross section of the bent portion for the presence or absence of a crack. Among the surfaces of the test piece in the bent portion, the surface that faced itself when the test piece in close-contact bending was referred to as the “inner surface”, and the surface opposite to the inner surface was referred to as the “outer surface” (see FIGS. 2A and 2B). The close-contact bendability was determined by the presence or absence of a crack on the outer surface in the bent portion (portion surrounded by a broken line in FIGS. 2A and 2B).

A test piece (bending test piece) subjected to close-contact bending was embedded in a resin, and an observation surface was prepared by mechanical polishing and buffing so that a surface perpendicular to the bending axis was a cross section (observation surface). The cross section (observation surface) was observed with an optical microscope (magnification: ×200 times) to determine the presence or absence of a crack on the outer surface in the bent portion. The term “crack” refers to what is observed as a thin split extending from the surface of the outer surface in the bent portion towards the inside of the sample piece.

In the example shown in FIG. 2A (Sample No. 1), no cracks were observed on the outer surface in the bent portion, and it was determined that “close-contact bending is possible (A)”. In the example shown in FIG. 2B (Sample No. 7), a crack was observed on the outer surface in the bent portion, and it was determined that “close-contact bending is impossible (B)”. The results of the determination are shown in the column “G. W. close-contact bendability” of Table 3.

TABLE 1

| | Sample | Chemical component composition (mass %): balance is Cu and inevitable impurity | | | | | |
|---|---|---|---|---|---|---|---|
| | No. | Ni | Si | Sn | Zn | Mg | Cr |
| Invention | 1 | 1.80 | 0.40 | 0.10 | 1.1 | 0 | 0 |
| Example | 2 | 1.80 | 0.40 | 0.10 | 1.1 | 0 | 0 |
| | 3 | 1.40 | 0.30 | 0.10 | 1.1 | 0 | 0 |
| | 4 | 1.40 | 0.30 | 0.10 | 1.1 | 0 | 0 |
| | 5 | 1.40 | 0.35 | 0.10 | 1.1 | 0.1 | 0 |
| | 6 | 1.80 | 0.40 | 0.10 | 1.1 | 0 | 0.04 |
| Comparative | 7 | 1.80 | 0.40 | 0.10 | 1.1 | 0 | 0 |
| Example | 8 | 1.80 | 0.40 | 0.10 | 1.1 | 0 | 0 |

TABLE 2

| | | | Solution | Aging | Finish | Low-temperature |
|---|---|---|---|---|---|---|
| | Sample | Sheet thickness | treatment | treatment | rolling | annealing |
| | No. | after pre-rolling | condition | condition | ratio | condition |
| Invention | 1 | 0.30 mm | 770° C. × 30 sec. | 450° C. × 5 hr. | 50% | 350° C. × 20 sec. |
| Example | 2 | 0.75 mm | 770° C. × 30 sec. | 450° C. × 5 hr. | 80% | 350° C. × 20 sec. |
| | 3 | 0.30 mm | 720° C. × 60 sec. | 450° C. × 5 hr. | 50% | 350° C. × 20 sec. |
| | 4 | 0.75 mm | 720° C. × 60 sec. | 450° C. × 5 hr. | 80% | 350° C. × 20 sec. |
| | 5 | 0.75 mm | 730° C. × 30 sec. | 450° C. × 5 hr. | 80% | 350° C. × 20 sec. |
| | 6 | 0.75 mm | 800° C. × 30 sec. | 450° C. × 5 hr. | 80% | 350° C. × 20 sec. |
| Comparative | 7 | 0.21 mm | 770° C. × 30 sec. | 450° C. × 5 hr. | 30% | 350° C. × 20 sec. |
| Example | 8 | 1.50 mm | 770° C. × 30 sec. | 450° C. × 5 hr. | 90% | 350° C. × 20 sec. |

TABLE 3

| | | Amount of shear bands | T.D. proof | G.W. close- | |
|---|---|---|---|---|---|
| | Sample | (total area fraction | stress | contact | Conductivity |
| | No. | with CI value <0.1) | (MPa) | bendability | (% IACS) |
| Invention | 1 | 35.2% | 749.8 | A | 41.0 |
| Example | 2 | 42.6% | 812.3 | A | 37.7 |
| | 3 | 13.7% | 674.2 | A | 44.3 |
| | 4 | 32.7% | 736.8 | A | 41.5 |
| | 5 | 39.8% | 796.7 | A | 37.2 |
| | 6 | 48.2% | 837.0 | A | 37.5 |
| Comparative | 7 | 5.6% | 669.3 | B | 42.2 |
| Example | 8 | 72.1% | 841.5 | B | 36.2 |

Samples Nos. 1 to 6, which were Invention Examples, satisfied the chemical component composition and the amount of shear bands determined in the present embodiment, and therefore a copper alloy sheet was obtained that had high proof stress, excellent G. W. close-contact bendability, and excellent balance between the proof stress and the bendability. It has been found that the copper alloy sheets of Samples Nos. 1 to 6 have a high conductivity and have no problem in use in electric and electronic components.

In Samples Nos. 7 to 8, which were Comparative Examples, the amount of shear bands was out of the range specified in the present embodiment, and therefore the G. W. close-contact bendability was low, and a crack was generated.

### INDUSTRIAL APPLICABILITY

The copper alloy sheet of the present disclosure has high strength and excellent G. W. close-contact bendability, and therefore the copper alloy sheet is suitable for fitting terminals and other terminal materials for automobiles and the like, and for conducting components for electric and electronic components such as relays, switches, and sockets.

This application claims priority based on Japanese Patent Application No. 2023-027680 filed on Feb. 24, 2023. Japanese Patent Application No. 2023-027680 is incorporated herein by reference.

1. A copper alloy sheet, comprising:
Ni: 1.2 to 3.0 mass %;
Si: 0.10 to 1.0 mass %;
Zn: 0.01 to 3.0 mass %; and
Cu,
wherein, in EBSD measurement on a cross-section in a thickness direction, within a depth range of up to 10% of a sheet thickness from the surface, a total area fraction of a portion having a CI value of less than 0.1 is 10.0% to 60.0%.

2. The copper alloy sheet according to claim 1, further comprising:
at least one element selected from the group consisting of Sn and Mg, in an amount of
Sn: 0 mass % to 1.0 mass %, and
Mg: 0 mass % to 0.2 mass %.

3. The copper alloy sheet according to claim 1, further comprising:
at least one element selected from the group consisting of Al, Mn, Cr, Ti, Zr, Fe, P, and Ag, in a total amount of more than 0 mass % to 0.5 mass %.

4. The copper alloy sheet according to claim 2, further comprising:
at least one element selected from the group consisting of Al, Mn, Cr, Ti, Zr, Fe, P, and Ag, in a total amount of more than 0 mass % to 0.5 mass %.
